(19) United States
(12) Patent Application Publication
(10) Pub. No.: US 2026/0111439 A1
(43) Pub. Date: Apr. 23, 2026

(54) AUTOMATED CONVERSION OF SOURCE DATABASE SCHEMA INTO DATA MODELS FOR CLOUD-BASED DATA ANALYTICS PLATFORMS

(71) Applicant: FMR LLC, Boston, MA (US)

(72) Inventors: Andrew Joseph Terminiello, Raleigh, NC (US); Dilip Wadilal Gandecha, Cary, NC (US); Senthilkumar Rajagopal, Morrisville, NC (US); John Ernest Cominio, Melbourne, FL (US); Stephen Ross Ellison, Jr., Durham, NC (US)

(21) Appl. No.: 19/357,458

(22) Filed: Oct. 14, 2025

Related U.S. Application Data
(60) Provisional application No. 63/710,767, filed on Oct. 23, 2024.

(51) Int. Cl. G06F 16/25; G06F 8/30

(52) U.S. Cl. CPC G06F 16/258; G06F 8/30

(57) ABSTRACT

Methods and apparatuses for automated conversion of source database schema into data models for cloud-based data analytics platforms include a server computing device that identifies database schema including one or more database tables in a source database for conversion and extracts metadata and schema information associated with the identified database schema from the source database. The server computing device converts the extracted metadata into a form compatible with a target cloud data analytics platform. The server computing device generates, using the converted metadata and the schema information, one or more code scripts comprising programmatic instructions to create a data model in the target cloud data analytics platform that is representative of the identified database schema. The server computing device executes the code scripts to create the data model in the target cloud data analytics platform and validates the created data model in the target cloud data analytics platform using the executed code scripts.

### RELATED APPLICATION(S)

This application claims priority to U.S. Provisional Ser. No. 63/710,767, filed on Oct. 23, 2024, the entirety of which is incorporated herein by reference.

### TECHNICAL FIELD

This application relates generally to methods and apparatuses, including computer program products, for automated conversion of source database schema into data models for cloud-based data analytics platforms.

### BACKGROUND

Many medium and large enterprise computing environments rely on a variety of cloud-based computing environments and service providers to provision and host end user software applications. Due to the scalability, speed, and distributed availability of cloud environments, organization-wide data analysis platforms (such as Snowflake™) that leverage the Data Vault 2.0 data modeling structure have become a driving feature behind the adoption of cloud infrastructure. However, a persistent challenge in the widespread use of cloud data analytics is the migration of legacy data and systems to the cloud. Migrating data from source locations into cloud-based data analysis platforms is a time-consuming process that typically requires extensive planning and creation of a Data Vault 2.0-compatible data model, plus a lot of repetitive database creation script writing. As can be appreciated, the above-described process is highly susceptible to errors and other inconsistencies (e.g., data model naming, data type conversion, script formatting) that have a significant impact on the migration delivery timeline and accuracy.

### SUMMARY

Therefore, what is needed are methods and systems for automatically generating cloud-compatible data models (including the creation of standardized code scripts) needed for data migrations from a plurality of discrete on-premises or legacy database systems into cloud data analysis platforms. The techniques described herein provide the benefit of an improved automation process for seamlessly instantiating data models in a target cloud-based data analytics platform using metadata and schema information provided from the respective source databases. In addition, the methods and systems advantageously enable validation of created data models and code scripts to ensure execution is accomplished successfully—as well as confirming accuracy and consistency of the data models with enterprise standards and regulatory requirements.

The technology, in one aspect, features a system for automated conversion of source database schema into data models for cloud-based data analytics platforms. The system includes a server computing device having a memory for storing computer-executable instructions and a processor that executes the computer-executable instructions. The server computing device identifies database schema including one or more database tables in a source database for conversion. The server computing device extracts metadata and schema information associated with the identified database schema from the source database. The server computing device converts the extracted metadata into a form compatible with a target cloud data analytics platform. The server computing device generates, using the converted metadata and the schema information, one or more code scripts comprising programmatic instructions to create a data model in the target cloud data analytics platform that is representative of the identified database schema. The server computing device executes the code scripts to create the data model in the target cloud data analytics platform. The server computing device validates the created data model in the target cloud data analytics platform using the executed code scripts.

The technology, in another aspect, features a computerized method of automated conversion of source database schema into data models for cloud-based data analytics platforms. A server computing device identifies database schema including one or more database tables in a source database for conversion. The server computing device extracts metadata and schema information associated with the identified database schema from the source database. The server computing device converts the extracted metadata into a form compatible with a target cloud data analytics platform. The server computing device generates, using the converted metadata and the schema information, one or more code scripts comprising programmatic instructions to create a data model in the target cloud data analytics platform that is representative of the identified database schema. The server computing device executes the code scripts to create the data model in the target cloud data analytics platform. The server computing device validates the created data model in the target cloud data analytics platform using the executed code scripts.

Any of the above aspects can include one or more of the following features. In some embodiments, the extracted metadata comprises column attributes for each of the database tables in the identified database schema. In some embodiments, the column attributes comprise column name, data type, primary key, foreign key, and null value flag for each column in the database table. In some embodiments, converting the extracted metadata into a form compatible with a target cloud data repository comprises updating the data type of one or more columns in the extracted metadata to match a target data type acceptable by the target data repository; and appending a target prefix value to the column name of one or more columns in the extracted metadata.

In some embodiments, the schema information comprises one or more data elements identifying a relationship between one or more of the database tables. In some embodiments, generating code scripts comprises selecting one or more code script templates for creating the data model in the target cloud data analytics platform; and populating one or more dynamic fields in the code script templates with one or more of: the converted metadata and the schema information. In some embodiments, the one or more code scripts comprise programmatic instructions to load data from the source database into the target data analytics platform. In some embodiments, validating the created data model comprises comparing one or more attributes of the executed code scripts to one or more attributes of the created data model for consistency.

Other aspects and advantages of the technology will become apparent from the following detailed description, taken in conjunction with the accompanying drawings, illustrating the principles of the technology by way of example only.

### BRIEF DESCRIPTION OF THE DRAWINGS

The advantages of the technology described above, together with further advantages, may be better understood by referring to the following description taken in conjunction with the accompanying drawings. The drawings are not necessarily to scale, emphasis instead generally being placed upon illustrating the principles of the technology.

FIG. 1 is a block diagram of a system for automated conversion of source database schema into data models for cloud-based data analytics platforms.

FIG. 2 is a flow diagram of a computerized method of automated conversion of source database schema into data models for cloud-based data analytics platforms.

FIGS. 3A-3E are diagrams of an exemplary user interface for identification of source database tables for conversion to a data model in a cloud-based data analytics platform.

FIG. 4 is a diagram of an exemplary structured data file format containing metadata from a source database table.

FIGS. 5A and 5B depict an exemplary data model conversion from a relational source database to a Data Vault 2.0 data model.

FIG. 6 is a diagram of an exemplary workflow to generate a code script for creating a landing table in a cloud-based data analysis platform.

FIG. 7 is an exemplary code script generated by script generation module using the template and user input from FIG. 6.

FIG. 8 is a diagram of a code script for creation of a hub table in the raw area of a cloud-based data analysis platform.

FIG. 9 is a diagram of a code script for creation of a satellite table in the raw area of a cloud-based data analysis platform.

FIG. 10 is a diagram of a code script for creation of a link table in the raw area of a cloud-based data analysis platform.

FIG. 11 is a diagram of a code script for loading data from a landing area into the hub table in the raw area of a cloud-based data analysis platform.

FIG. 12 is a diagram of a code script for loading data from the landing area into the satellite table in the raw area of a cloud-based data analysis platform.

FIG. 13 is a diagram of a code script for loading data from the landing area into the link table in the raw area of a cloud-based data analysis platform.

FIG. 14 is a diagram of an exemplary EDA configuration file based on source database table information.

### DETAILED DESCRIPTION

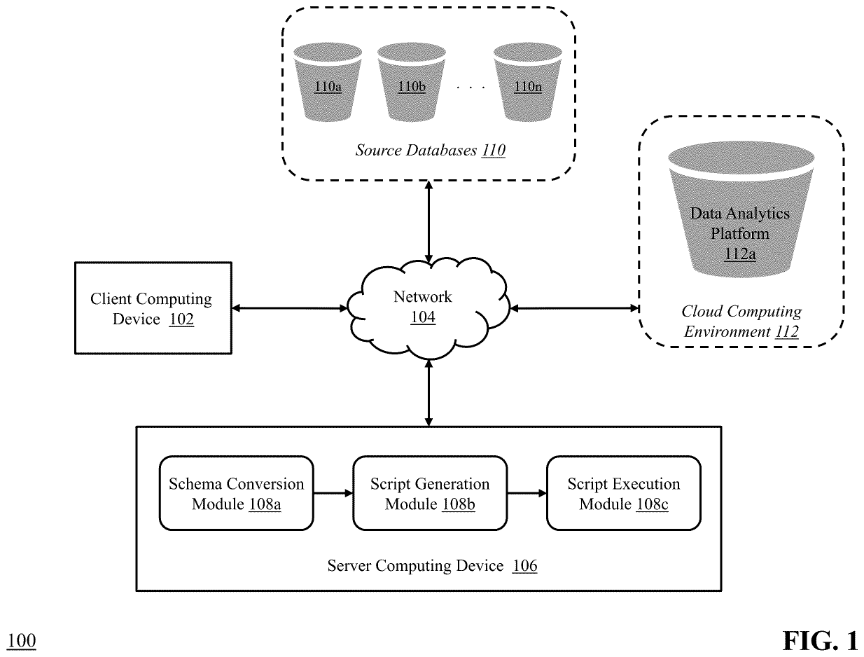

FIG. 1 is a block diagram of a system 100 for automated conversion of source database schema (e.g., database tables and relationships between tables) into data models for cloud-based data analytics platforms. System 100 includes client computing device 102, communications network 104, server computing device 106 that includes schema conversion module 108a, script generation module 108b and script execution module 108c, a plurality of source databases 110a-110n (collectively, 110) and cloud computing environment 112 with data analytics platform 112a.

Client computing device 102 connects to one or more communications networks (e.g., network 104) in order to communicate with server computing device 106 to provide input and receive output relating to automated conversion of source database schema into data models for cloud-based data analytics platforms as described herein. Exemplary client computing devices 102 include but are not limited to desktop computers, laptop computers, tablets, mobile devices, smartphones, web application servers, database management platforms, software-as-a-service (SaaS) platforms, sysadmin control devices, and the like. It should be appreciated that other types of computing devices that can connect to the components of system 100 can be used without departing from the scope of the technology described herein. Although FIG. 1 depicts a single client computing device 102, it should be appreciated that system 100 can include any number of client computing devices.

Communication network 104 enables client computing device 102 to communicate with server computing device 106 and enables server computing device 106 to communicate with source databases 110 and cloud computing environment 112. Network 104 is typically a wide area network, such as the Internet and/or a cellular network. In some embodiments, network 104 is comprised of several discrete networks and/or sub-networks (e.g., cellular to Internet). In some embodiments, network 104 can be part of the same overall network topography to enable server computing device 106 to connect to client computing device 102, source databases 110 and/or cloud computing environment 112 using the same network.

Server computing device 106 is a device including specialized hardware and/or software modules that execute on one or more processors and interact with one or more memory modules of server computing device 106, to receive data from other components of system 100, transmit data to other components of system 100, and perform functions for automated conversion of source database schema into data models for cloud-based data analytics platforms as described herein. As mentioned above, server computing device 106 includes schema conversion module 108a, script generation module 108b and script execution module 108c. In some embodiments, modules 108a-108c are specialized sets of computer software instructions programmed onto one or more dedicated processors in the server computing device. Although modules 108a-108c are shown in FIG. 1 as executing within the same server computing device 106, in some embodiments the functionality of modules 108a-108c can be distributed among one or a plurality of other computing devices that are coupled to the server computing device 106. It should be appreciated that any number of computing devices, arranged in a variety of architectures, resources, and configurations (e.g., cluster computing, virtual computing, cloud computing) can be used without departing from the scope of the technology described herein. The functionality of the modules 108a-108c will be described in greater detail throughout this specification.

Source databases 110 comprise data storage hardware and/or software applications (e.g., database platforms, data warehouses, or other types of data repositories) that store data associated with one or more enterprises and/or applications. In some embodiments, source databases 110 are comprised of one or more database types residing on a plurality of distributed computing systems. For example, database 110a can comprise a database operated on the Oracle® software relational database platform, database 110b can comprise a NoSQL data store that uses the DynamoDB® infrastructure, while database 110n can comprise a legacy DB2® mainframe. It should be appreciated that databases 110 can comprise other database types or frameworks that can connect to network 104 and interfacing with server computing device 106.

Cloud computing environment 112 is a combination of hardware, including one or more special-purpose processors and one or more physical memory modules, and specialized software—such as data lake 112a—that are executed by processor(s) of one or more computing devices in cloud computing environment 108, to receive data from other components of system 100, transmit data to other components of system 100, and perform functions for automated conversion of source database schema into data models for cloud-based data analytics platforms as described herein. Cloud computing environment 112 can be configured to execute many instances of applications and supporting software (e.g., containers, processes) in isolation from each other, that access a single operating system (OS) kernel. In some embodiments, cloud computing environment 112 executes each instance in a separate OS process and constrains each instance's access to physical resources (e.g., CPU, memory) of the corresponding cloud computing device(s) so that a single instance does not utilize all of the available physical resources. Upon execution, one or more computing devices in cloud computing environment 112 executes application code and data in an instance for delivery, configuration, monitoring, presentation, and/or manipulation of application functions and associated data by one or more endpoint devices. In one embodiment, cloud computing environment 112 is deployed using a commercially available cloud computing platform such as Amazon® AWS™, Microsoft® Azure™, IBM® Cloud and/or Google® Cloud.

In some embodiments, computing resources of cloud computing environment 112 can be distributed into a plurality of regions which can be defined according to certain geographic and/or technical performance requirements. Each region can comprise one or more datacenters connected via a regional network that meets specific low-latency requirements. Inside each region, cloud computing environment 112 can be partitioned into one or more availability zones (AZ), which are physically separate locations used to achieve tolerance to, e.g., hardware failures, software failures, disruption in connectivity, unexpected events/disasters, and the like. Typically, the availability zones are connected using a high-performance network (e.g., round trip latency of less than two milliseconds). It should be appreciated that other types of computing resource distribution and configuration in a cloud environment can be used within the scope of the technology described herein.

Data analytics platform 112a resides in cloud computing environment 112 and enables an organization to access and share enterprise data for a multitude of end user software applications. Exemplary data analytics platforms 112a include, but are not limited to, Amazon® Redshift™ available from Amazon, Inc.; Microsoft® Azure™ available from Microsoft Corp.; Oracle® Cloud Infrastructure™ (OCI) available from Oracle Corp.; Google® BigQuery™ available from Google, Inc.; and Snowflake™ Data Cloud available from Snowflake, Inc. It should be appreciated, however, that the techniques and advancements described herein are not solely limited to cloud-based data analytics platforms. These improvements can be applied to other types of cloud-based or non-cloud-based data stores as well, including heterogeneous source databases and other data repositories. In some embodiments, server computing device 106 can be hosted in cloud computing environment 112, or server computing device 106 can be located on a separate computing device that is external to the cloud computing environment 112.

As described previously, many organizations are migrating enterprise data to the cloud that is currently stored in disparate computing systems, architectures, software platforms, and geographic locations across the organization—in order to take advantage of the scalability, flexibility, security, collaboration features, and ease of use offered by cloud-based data analytics platforms. However, this process requires significant time and resource investment from developers and system administrators to prepare the required data models and migration scripts for storage of the enterprise data in the cloud-based data analytics platform. In addition, certain on-premises or legacy data stores may not be readily compatible with the data model requirements imposed by a cloud-based data analytics platform. In view of these challenges, the methods and systems described herein provide an improved process for seamlessly instantiating and validating data models in a target cloud-based data analytics platform using metadata and schema information provided from the respective source databases.

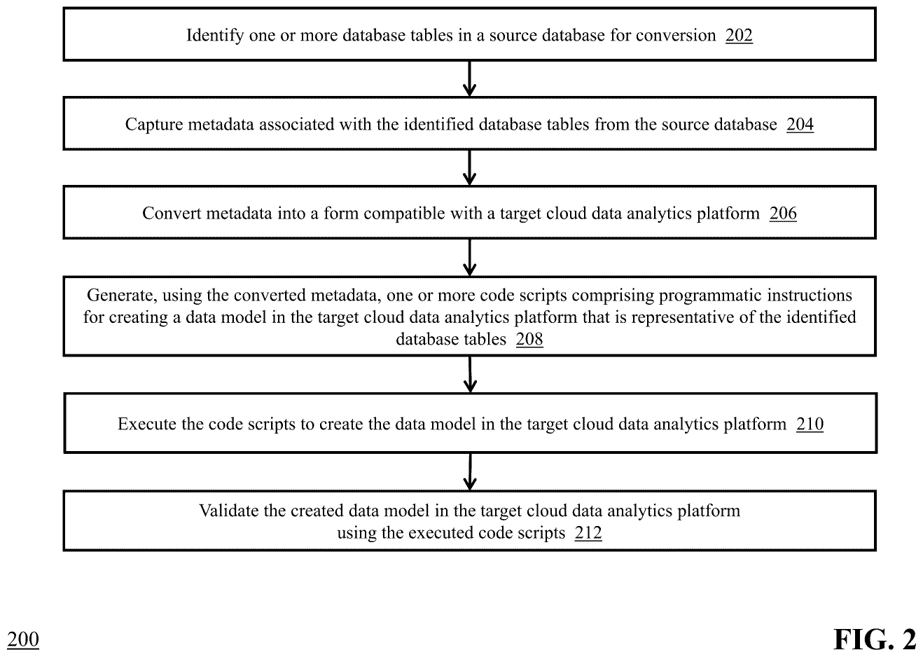

FIG. 2 is a flow diagram of a computerized method 200 of automated conversion of source database schema into data models for cloud-based data analytics platforms, using system 100 of FIG. 1. In some embodiments, server computing device 106 is accessible by software installed at client computing device 102 to enable client computing device 102 to connect to server computing device 106 (e.g., via an HTTP session in a browser), provide commands for the creation of data model(s) in target cloud data analytics platform (e.g., platform 112a) based upon database tables and schema in one or more source databases 110, and to migrate corresponding data from the source databases 110 to the cloud data analytics platform (112a), and receive and view UI screens associated with the status and progress of data model creation and data migration in cloud computing environment 112. For example, upon logging into server computing device 106, a user at client computing device 102 can interact with schema conversation module 108a to identify (step 202) one or more database tables in a source database 110a for conversion to a data model in data analytics platform 112a.

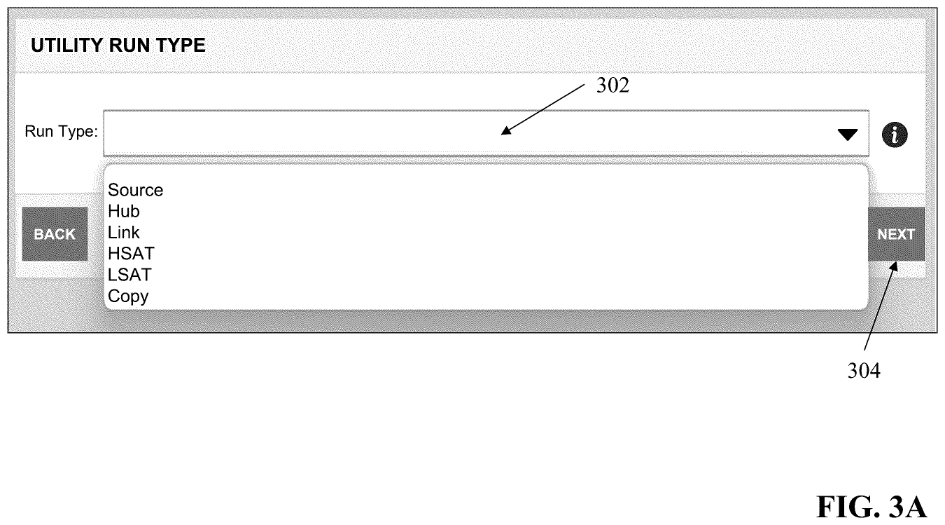

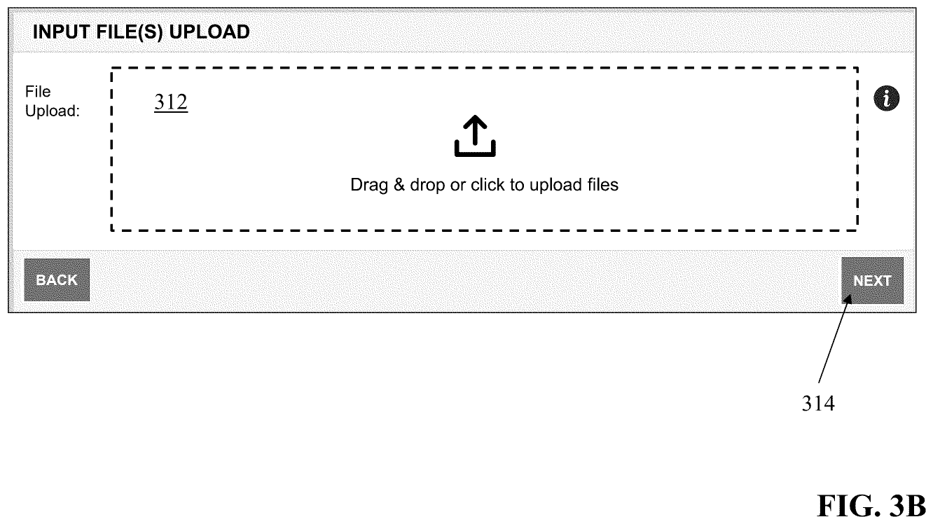

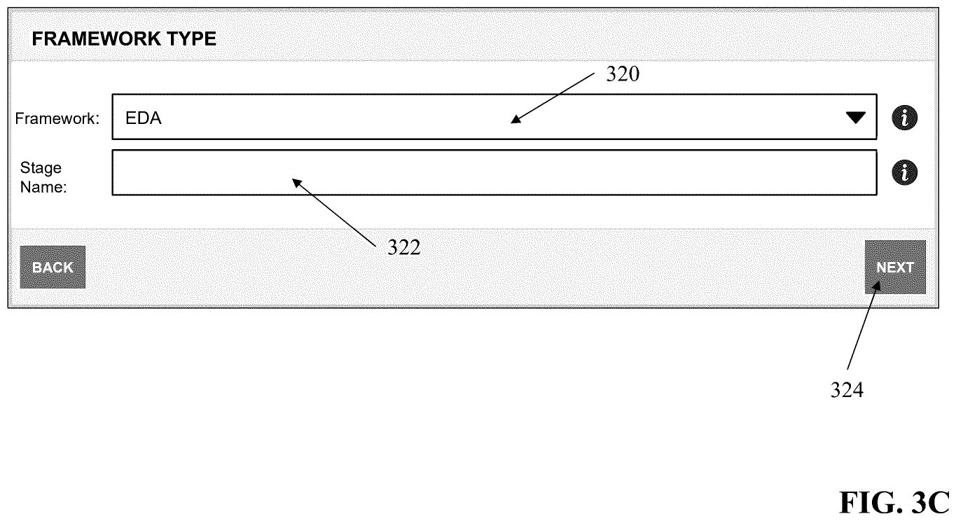

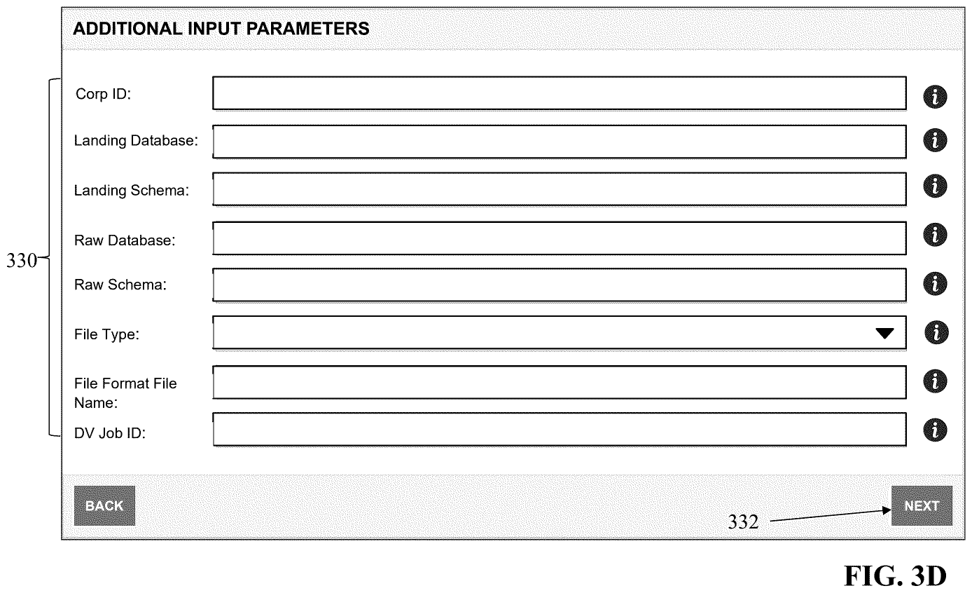

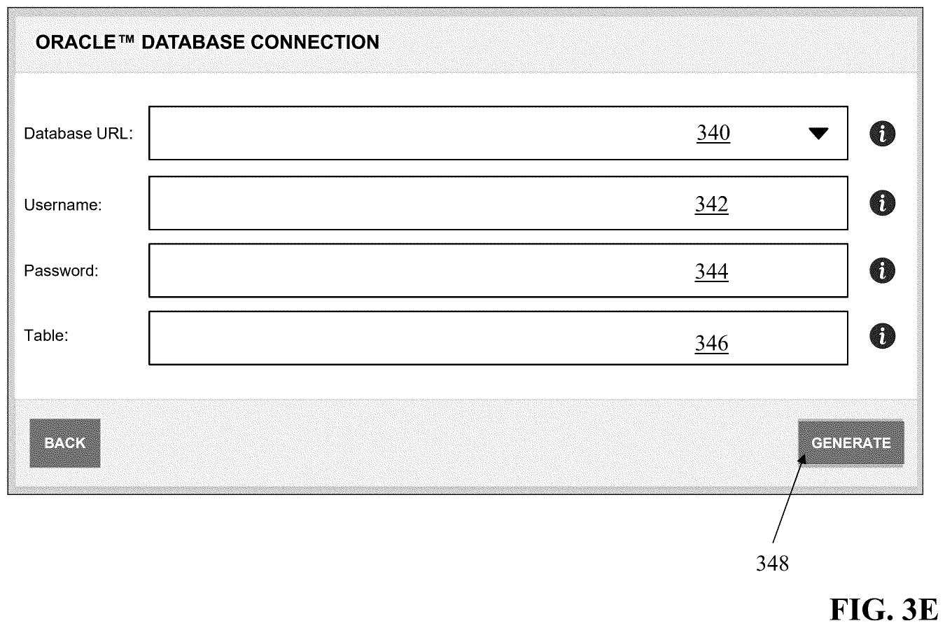

FIGS. 3A to 3E are diagrams of exemplary user interfaces for identification of source database schema for conversion to a data model in platform 112a. As shown in FIG. 3A, a user interface includes user interface elements that enable an end user at client computing device 102 to select a run type for the schema conversion and data model creation process. For example, a user at client computing device 102 can interact with drop down menu 302 to choose from a variety of run type options (e.g. Source, Hub, Link, HSAT, LSAT, Copy), which may relate to how the data model will be constructed in the platform 112a. In one example, the Source run type means that the arrangement and structure of the data model being created in the platform 112a will conform to the arrangement and structure of the data in the source database. In other examples, the Hub, Link, HSAT, LSAT run types relate to a Data Vault 2.0 implementation in the data model—e.g., the Hub run type means that the arrangement and structure of the data model being created in the platform 112a will conform to a Hub model as defined in the Data Vault 2.0 specification, and likewise for Link, HSAT, and LSAT run types. Once the user has selected a run type, the user can click the Next button 304 to proceed to the next user interface screen in the utility (see FIG. 3B).

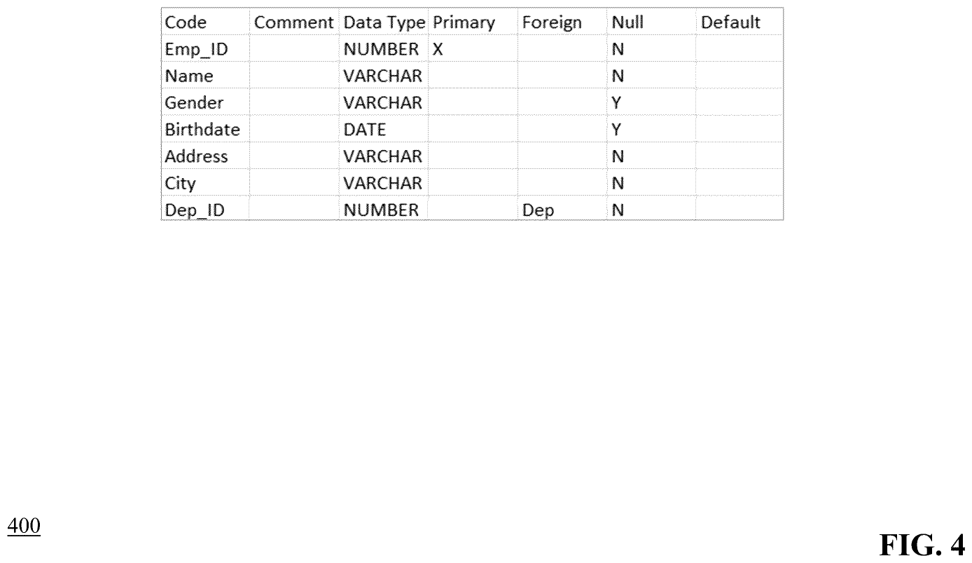

As shown in FIG. 3B, a user interface includes user interface elements that enable an end user at client computing device 102 to upload one or more input files to schema conversion module 106a that contains metadata corresponding to the source schema to be converted. For example, the user can drag and drop one or more structured data files into area 312 and/or click the icon in area 312 to select a structured data file (e.g., .csv file, .json file) stored locally on client computing device 102 or on another computing device, that defines the metadata from the source database schema to be converted. FIG. 4 is a diagram of an exemplary structured data file format 400 containing metadata from a source database table. As shown in FIG. 4, the metadata includes a ‘code’ field which contains the column name from the source table, a ‘comment’ field to contain any developer comments associated with the column, a ‘data type’ field indicating the data type of the source column, a ‘primary’ field indicating whether the column is a primary key in the source table, a ‘foreign’ field indicating whether the column is a foreign key, a ‘null’ field indicating whether the column can contain NULL values, and a ‘default’ field to contain a value to be inserted into the column when no value is specified. Turning back to FIG. 3B, once the user has uploaded input file(s), the user can click the Next button 314 to proceed to the next user interface screen in the utility (see FIG. 3C).

As shown in FIG. 3C, a user interface includes user interface elements that enable an end user at client computing device 102 to select a framework and stage name for the data model structure and/or workflow in the data analytics platform 112a that will be used to load the converted data. For example, the user can interact with drop down menu 320 to select a framework (e.g., EDA) and interact with input field 322 to provide a stage name that indicates the location where data files will be stored (staged) for loading data into the data analytics platform 112a. In some embodiments, by selecting EDA, the user is denoting that code scripts should be created to configure the target data model according to an event-driven architecture framework in the platform 112a. In some embodiments, the EDA framework is implemented in platform 112a as a job scheduling orchestration framework which executes the generated code scripts. It should be appreciated that other types of data migration and job scheduling frameworks can be selected for use in the data model creation process, such as Control-M. Once the user has selected a framework and a stage name, the user can click the Next button 324 to proceed to the next user interface screen in the utility (see FIG. 3D).

As shown in FIG. 3D, a user interface includes user interface elements that enable an end user at client computing device 102 to provide additional input parameters for the process of automated conversion of source database schema into data models for cloud-based data analytics platforms as performed by server computing device 106. For example, the user can enter data into one or more of the fields 330 to provide input relating to, e.g., the data analytics platform 112a in which the data model(s) will be created. In one embodiment, the user at client computing device 102 can provide indicia in fields 330 to identify the landing database name and landing schema name for platform 112a in which the data model will be created and data from the source schema will be stored. The user can also specify the raw database name and raw schema name for platform 112a in which the data model will be created and data from the source schema will be stored. When the user has completed data entry in the applicable fields 330, the user can click the Next button 332 to proceed to the next user interface screen in the utility (see FIG. 3E).

As shown in FIG. 3E, a user interface includes user interface elements that enable an end user at client computing device 102 to provide parameters to identify the source database(s) 110 from which the tables/schema will be extracted to create migration code scripts. In some embodiments, the user at client computing device 102 can provide a source database URL in field 340, authentication credentials (e.g., username and password) to access the database in fields 342 and 344, and source database schema (e.g., a database table) in field 346 of FIG. 3E. The user can then click the Next button 348 to initiate generation of the code scripts conversion of the source database table into the platform 112a data model.

Upon initiating the code generation, schema conversion module 106a connects to the source database and captures (step 204 of FIG. 2) metadata and schema information stored in the source database to generate the structured data file. For example, schema conversion module 106a can determine that the ‘Emp_ID’ column is a primary key column and set the value of the ‘primary’ flag in the structured data file to ‘X’ (see FIG. 4). In some embodiments, schema conversion module 106a extracts corresponding metadata from the source database and inserts the extracted metadata into the structured data file. For example, schema conversion module 106a captures the column names for each column in the source database table and inserts the captured column names into the structured data file.

Once the metadata is captured from the source database, schema conversion module 106a converts (step 206) the metadata into a form compatible with the target cloud data analytics platform 112a. As can be appreciated, the target platform 112a may have different naming conventions, data type requirements, or other data configuration and storage parameters than the source database 110. As an example, the source database 110 may store string values using a VARCHAR data type without a defined maximum length, while the target platform 112a may require string data to have a maximum length. In this example, schema conversion module 106a can convert the VARCHAR data type for columns in the structured data file into corresponding VARCHAR(x) data types, where x denotes a specific character length. In some embodiments, schema conversion module 106a can be configured to utilize a mapping table when performing such conversions, where the mapping table associates metadata values found in one or more source databases 110 to metadata values required by the target platform 112a. Where the source database 110a is based on the Oracle™ database software platform and the target data analysis platform 112a is Snowflake, the mapping table can include an association between certain metadata values for Oracle (e.g., data types, column names, etc.) and associate those metadata values with corresponding metadata values for the Snowflake data analysis platform 112a. In some embodiments, schema conversion module 106a can modify the input structured data file to incorporate the metadata values required by the target data analysis platform 112a and/or create a new version of the structured data file with the changed metadata.

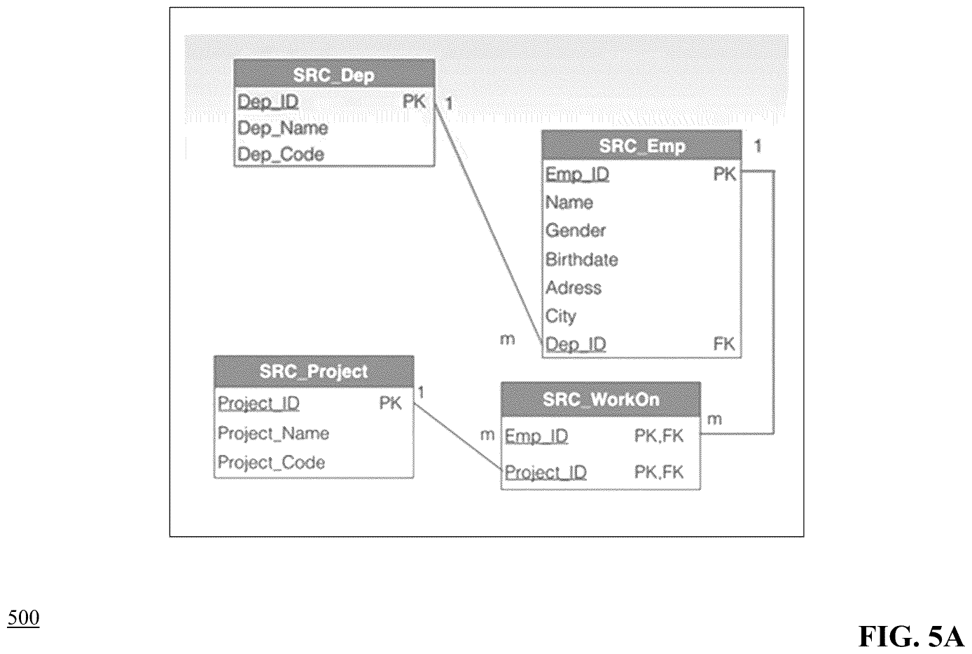

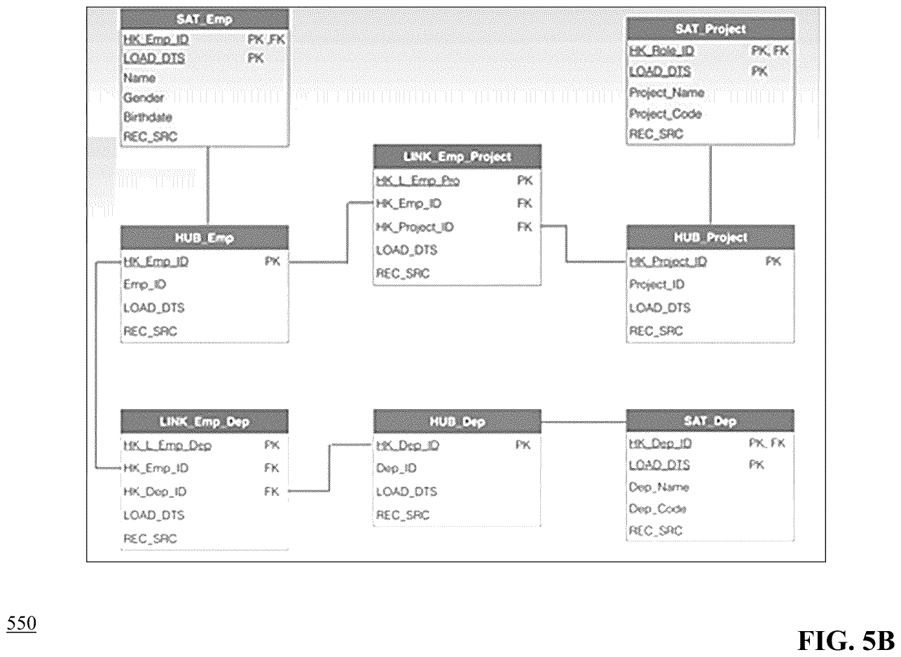

In some embodiments, in addition to converting the metadata, schema conversion module 106a converts the data model of the schema/table(s) in the source database 110 to a data model that is compatible with the target data analytics platform 112a. In one example, the source database 110a can be a relational database (e.g., Oracle) using a relational data model, and the target data analytics platform 112a can use a Data Vault 2.0 data model with hub, satellite, and link tables. Schema conversion module 106a can analyze the metadata and database schema information captured from the source database 110a and generate a corresponding data model for the target platform 112a. FIGS. 5A and 5B depict an exemplary data model conversion performed by schema conversion module 106a from a relational source database to a Data Vault 2.0 data model. As shown in FIG. 5A, the source database data model 500 includes a plurality of tables (SRC_Emp, SRC_Dep, SRC_Project, SRC_WorkOrder) joined via primary key-foreign key relationships. As shown in FIG. 5B, the corresponding Data Vault 2.0 data model created by module 106a includes a plurality of hub tables (denoted by the prefix ‘HUB_’), satellite tables (denoted by the prefix ‘SAT_’), and link tables (denoted by the prefix ‘LINK_’) that connect hub tables and satellite tables.

Schema conversion module 106a provides the converted metadata values to script generation module 106b of server computing device 106, which uses the converted metadata and schema information to generate (step 208) one or more code scripts comprising programmatic instructions for creating the data model in the target cloud data analytics platform 112a, where the created data model is representative of the database schema from the source database 110 that were identified in step 202. In some embodiments, the programmatic instructions in the code scripts comprise a multi-phase data model creation and data migration process: 1) creating a data model in a landing schema in the data analytics platform 112a and loading data from the source database into the landing schema data model; 2) creating a data model in a raw schema in the data analytics platform 112a; and 3) loading data from the source database into the data model of the raw schema. Script generation module 106b identifies a plurality of pre-generated code script templates that are configured to carry out the data model creation and data migration process. Module 106b then modifies certain aspects of the code script templates based upon the converted metadata and schema information received from module 106a.

As an example, script generation module 106b can determine that the following code scripts must be executed to complete the data model creation and data migration process:
a) create landing table(s) in the landing area of target platform 112a;
b) populate the landing table(s) with data from the source database table(s);
c) create hub table(s) in the raw area of target platform 112a;
d) create satellite table(s) in the raw area of target platform 112a;
e) create link table(s) in the raw area of target platform 112a; and
f) load data into hub table(s), satellite table(s), and link table(s) in the raw area of target platform 112.

Script generation module 106b retrieves code script templates for each of the above steps and uses the converted metadata and schema information from the source database 110 to generate code scripts that, when executed by script execution module 108c, operate to create the data model(s) in data analytics platform 112a and to migrate the data from source database(s) 110 to the platform 112a.

In some embodiments, a code script template comprises a file containing pre-written code elements (typically, commonly re-used, generic, or repeatable code) as well as dynamic fields (e.g., at least a portion of the user input from interface 300 and/or the metadata and schema information captured from the source database(s)) that are populated by script generation module 106b during generation of code scripts. The result of the script generation process is one or more code script templates that are customized for the tasks required to generate the new data model in platform 112a and to migrate data from source database 110 through one or more data preparation stages in platform 112a. Code script templates provide several advantages over individual creation of code scripts for each data migration process, including maintaining a consistent structure and syntax for each set of code scripts and reducing the developer time needed to prepare and execute the data model creation pipeline. In some embodiments, script generation module 106b can leverage advanced computing techniques and modules, such as a large language model (LLM) or other generative AI model, to assist in generating the code scripts. For example, module 106b can provide the code template and metadata/schema information in a prompt for the LLM, which dynamically creates the customized code scripts.

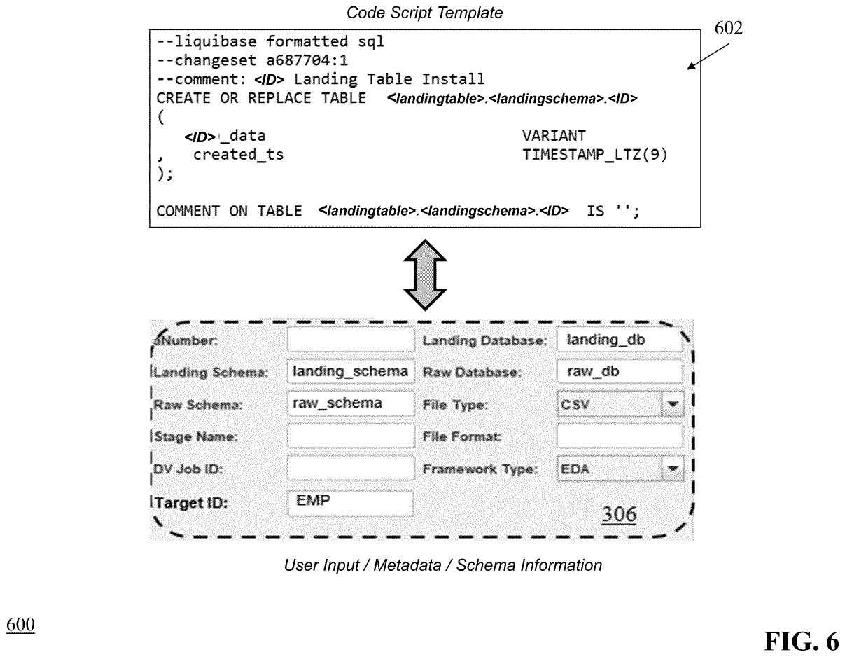

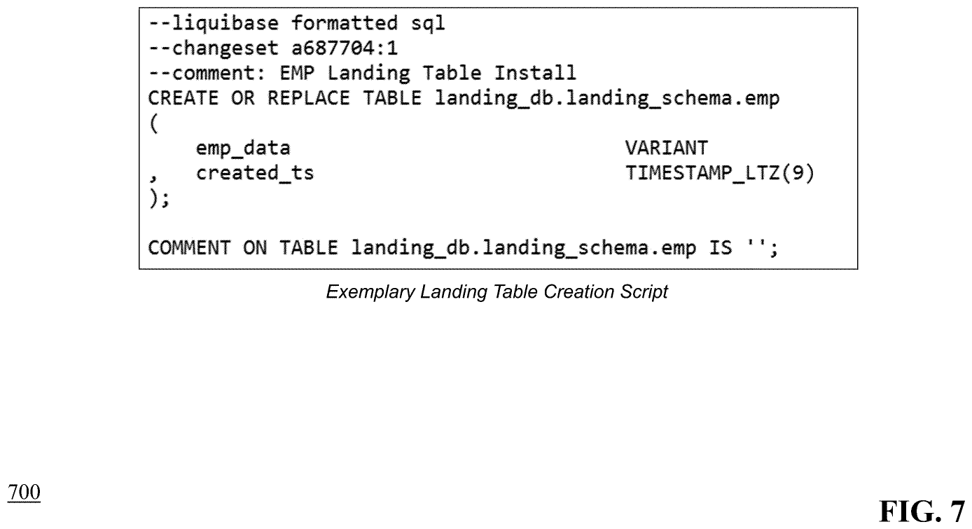

FIG. 6 is a diagram of an exemplary workflow 600 performed by script generation module 106b to generate a code script for creating a landing table in data analysis platform 112a. As shown in FIG. 6, module 106b identifies a code script template 602 to be used for generating a custom code script. The template 602 includes one or more dynamic fields (e.g., <ID>) that indicate areas in the template where module 106b inserts captured information. In this example, script generation module 106b inserts data from section 306 of user interface 300 into the dynamic fields of code script template 602 and saves the customized code script in, e.g., local memory. FIG. 7 is an exemplary code script 700 generated by script generation module 106b using the template 602 and user input from FIG. 6. As shown in FIG. 7, the script 700 comprises programmatic instructions executable by script execution module 106c for creation of the ‘emp’ table in a landing area of data analysis platform 112a. The table includes two columns: ‘emp_data’ (which will contain data from the corresponding source database table) and ‘created_ts.’ (a timestamp denoting when the data was stored in the ‘emp’ table).

Script generation module 106b can perform the script generation process described above for a plurality of different code scripts that may be required, based upon the input data, schema, and metadata. FIGS. 7-14 depict exemplary code scripts generated by module 106b to execute a data model creation and data migration process for a source database table (i.e., the source table defined in FIG. 4). The code scripts of FIGS. 7-14 are written for execution by the SnowSQL command line interface for interacting with the Snowflake cloud data analysis platform. However, it should be appreciated that these scripts are merely exemplary and other scripting languages can be used within the scope of technology described herein. As mentioned above, FIG. 7 is a diagram of a code script 700 for creation of a landing table in the landing area of platform 112a for storing data from a source database ‘employee’ table (as defined in FIG. 4).

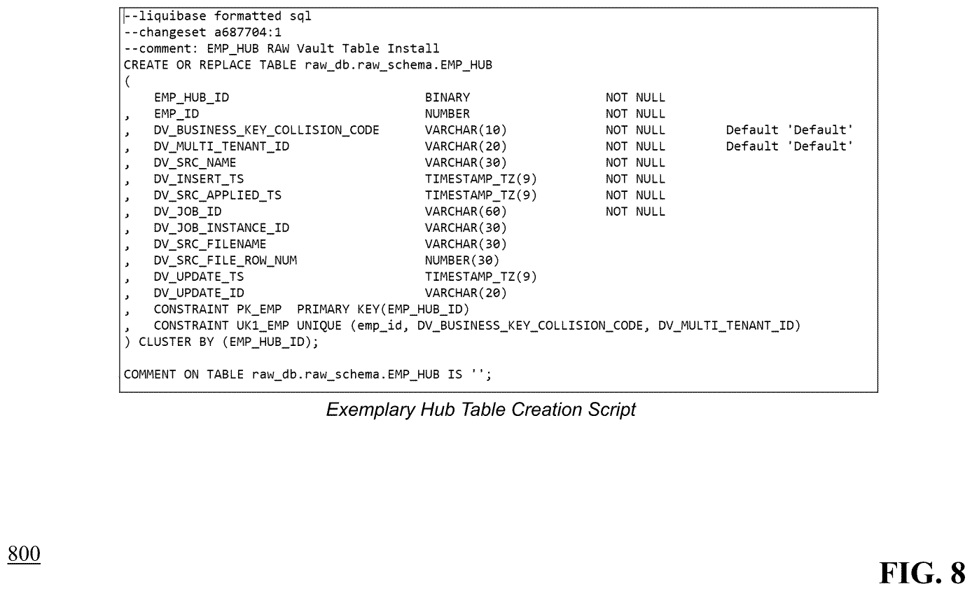

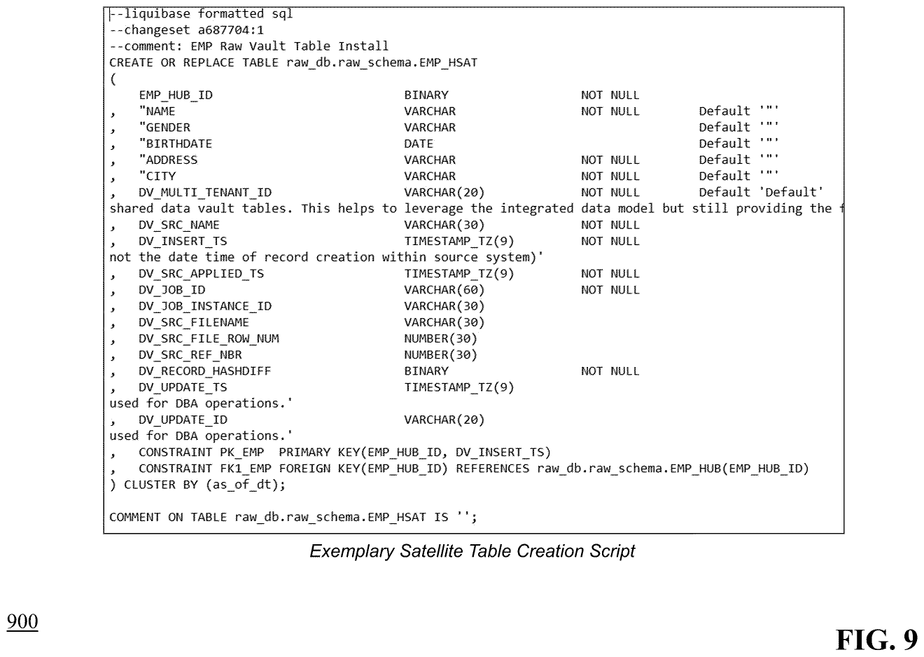

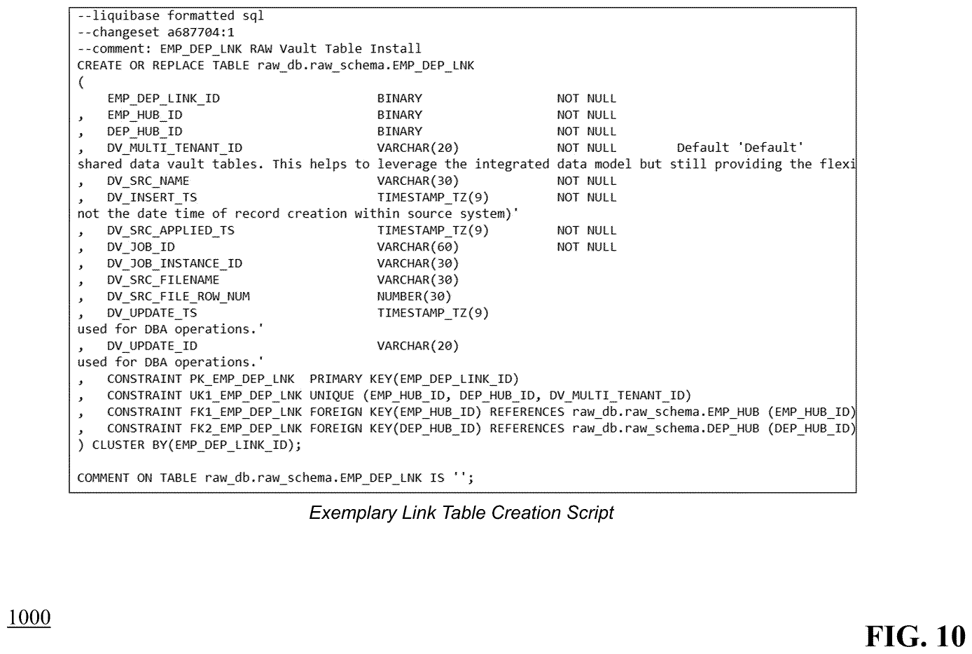

FIG. 8 is a diagram of a code script 800 for creation of a hub table in the raw area of platform 112a for storing data from the source database ‘employee’ table. FIG. 9 is a diagram of a code script 900 for creation of a satellite table in the raw area of platform 112a for storing data from the source database ‘employee’ table. FIG. 10 is a diagram of a code script 1000 for creation of a link table in the raw area of platform 112a for storing data from the source database ‘employee’ table. As can be appreciated, after script generation module 106b creates the code scripts of FIGS. 7-10, script execution module 106c executes (step 210) the code scripts to create the data model (including hub, satellite, and link tables) for the source database ‘employee’ table in target data analytics platform 112a.

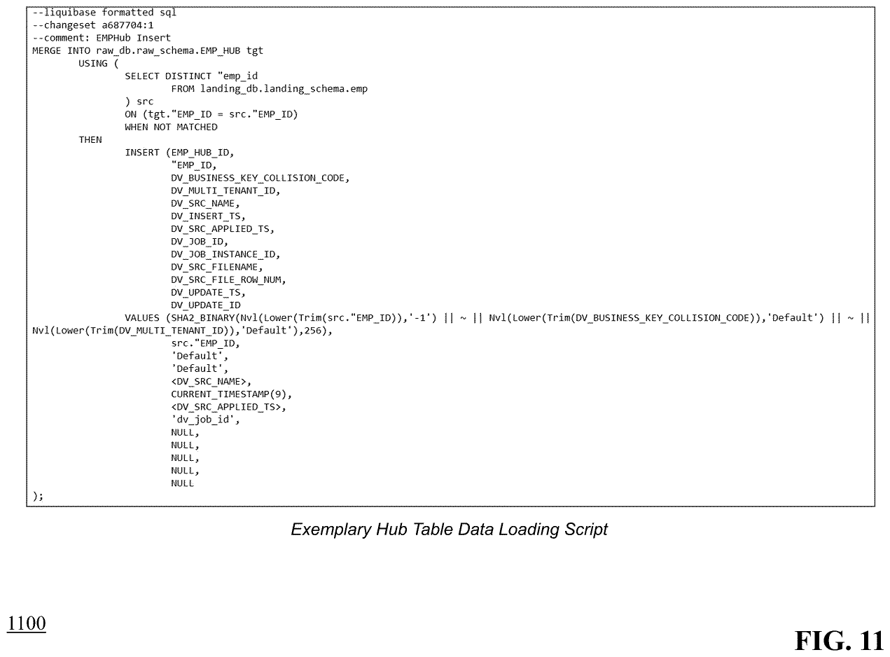

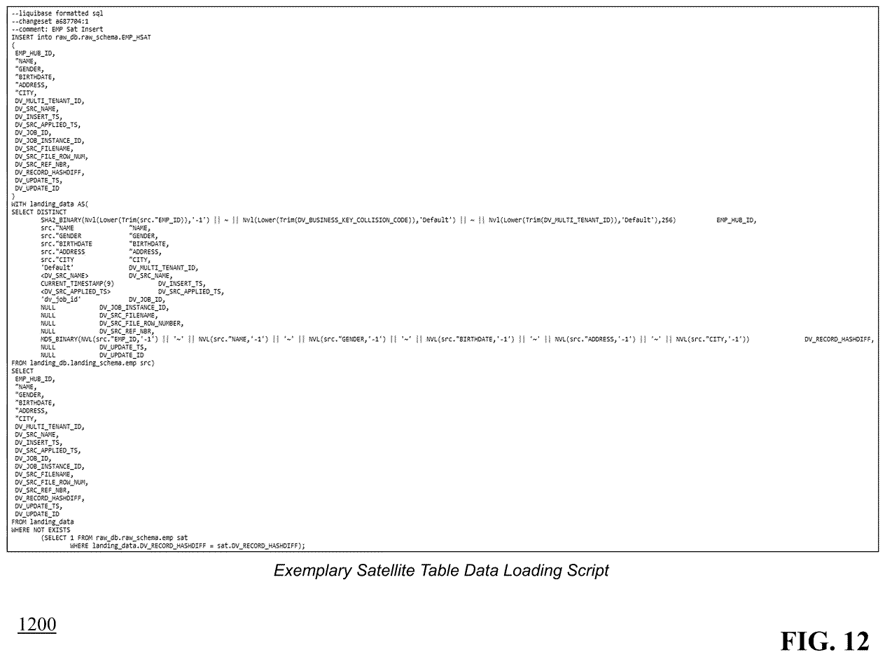

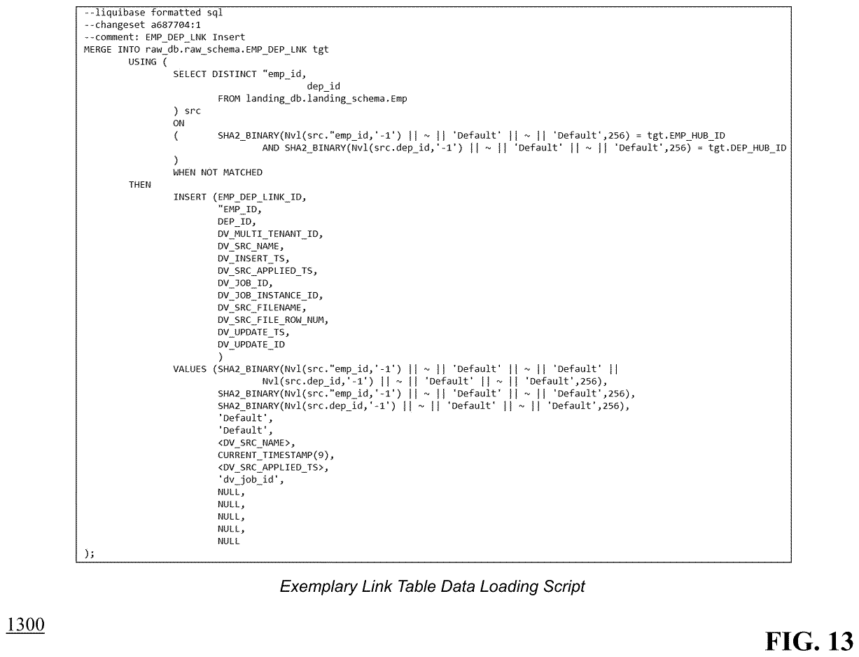

Once the data model is created in platform 112a, script execution module 106c can execute one or more data loading scripts created by module 106b to populate the new data model with source data. As shown in FIGS. 11-13, the code scripts for loading data into the new data model are configured to retrieve data from the landing area (e.g., the ‘emp’ landing table created by script 700) for population into the hub, satellite, and link tables in the raw area. However, in other embodiments, the code scripts can retrieve data from other location(s), including but not limited to, directly from the source database(s) 110. FIG. 11 is a diagram of a code script 1100 for loading data from the landing area ‘emp’ table into the hub table in the raw area of platform 112a. FIG. 12 is a diagram of a code script 1200 for loading data from the landing area ‘emp’ table into the satellite table in the raw area of platform 112a. FIG. 13 is a diagram of a code script 1300 for loading data from the landing area ‘emp’ table into the link table in the raw area of platform 112a.

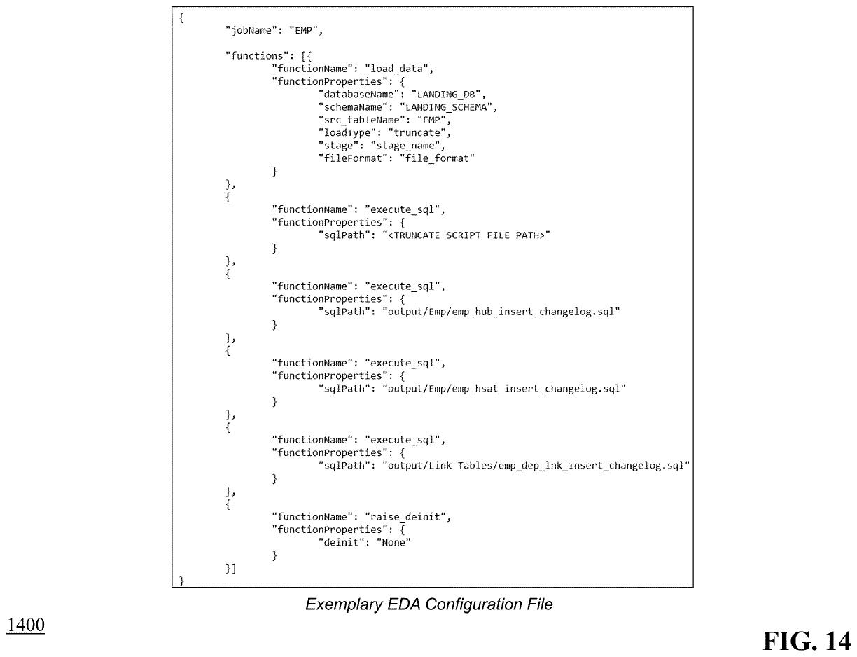

In some embodiments, script generation module 106b is configured to create one or more additional scripts or files to support the data model creation and data migration process described above. FIG. 14 is a diagram of an exemplary EDA configuration file 1400 generated by module 106b based on the source database table information (e.g., user input, metadata and/or schema). In some embodiments, the purpose of the EDA configuration file 1400 is to enable platform 112a to execute the code scripts generated by script generation module 106b, e.g., to Truncate and Load the data into the landing and raw areas of platform 112a.

Once the generated code scripts are executed by script execution module 106c, the new data model is available for use in data analytics platform 112a. In some embodiments, the data model is first created in a test or QA environment of platform 112a so that support personnel can confirm that modules 106a-106c successfully created and populated the data model based upon the requirements provided by the end user. In addition, the data model and associated data can be queried and tested to ensure proper functioning and storage of the data. In some embodiments, script execution module 106c automatically validates (step 212) the created data model in the target data analytics platform 112a using the executed code scripts. For example, code execution module 106c can be configured to parse each of the code scripts that were executed and extract relevant data (e.g., column names, data types, etc.) associated with the data model created in platform 112a. Then, module 106c can query platform 112a to capture data model attributes and compare the extracted data to the data received from platform 112a to ensure consistency and accuracy. Also, in some embodiments, script execution module 106c is configured to execute one or more data query operations against the data model in platform 112a and compare the results from the query operations to expected values (and/or to query results from the source database table) and determine whether the data model contains accurate data.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

The computer program can be deployed in a cloud computing environment (e.g., Amazon® AWS, Microsoft® Azure, IBM® Cloud™). A cloud computing environment includes a collection of computing resources provided as a service to one or more remote computing devices that connect to the cloud computing environment via a service account—allowing access to the computing resources. Cloud applications use various resources that are distributed within the cloud computing environment, across availability zones, and/or across multiple computing environments or data centers. Cloud applications are hosted as a service and use transitory, temporary, and/or persistent storage to store their data. These applications leverage cloud infrastructure that eliminates the need for continuous monitoring of computing infrastructure by the application developers, such as provisioning servers, clusters, virtual machines, storage devices, and/or network resources. Instead, developers use resources in the cloud computing environment to build and run the application and store relevant data.

Method steps can be performed by one or more processors executing a computer program to perform functions of the technology described herein by operating on input data and/or generating output data. Subroutines can refer to portions of the stored computer program and/or the processor, and/or the special circuitry that implements one or more functions. Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random-access memory or both. The essential elements of a computer are a processor for executing instructions and one or more memory devices for storing instructions and/or data. Exemplary processors can include, but are not limited to, integrated circuit (IC) microprocessors (including single-core and multi-core processors). Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), an ASIC (application-specific integrated circuit), Graphics Processing Unit (GPU) hardware (integrated and/or discrete), another type of specialized processor or processors configured to carry out the method steps, or the like.

Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices (e.g., NAND flash memory, solid state drives (SSD)); magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above-described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). The systems and methods described herein can be configured to interact with a user via wearable computing devices, such as an augmented reality (AR) appliance, a virtual reality (VR) appliance, a mixed reality (MR) appliance, or another type of device. Exemplary wearable computing devices can include, but are not limited to, headsets such as Meta™ Quest 3™ and Apple® Vision Pro™. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above-described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above-described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN),), a private IP network, an IP private branch exchange (IPBX), a wireless network (e.g., radio access network (RAN), Bluetooth™, near field communications (NFC) network, Wi-Fi™, WiMAX™, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), cellular networks, and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE), cellular (e.g., 4G, 5G), and/or other communication protocols.

Devices of the computing system can include, for example, a computer, a computer with a browser device, a telephone, an IP phone, a mobile device (e.g., cellular phone, personal digital assistant (PDA) device, smartphone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Safari™ from Apple, Inc., Microsoft® Edge® from Microsoft Corporation, and/or Mozilla® Firefox from Mozilla Corporation). Mobile computing devices include, for example, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

The methods and systems described herein can utilize artificial intelligence (AI) and/or machine learning (ML) algorithms to process data and/or control computing devices. In one example, a classification model, is a trained ML algorithm that receives and analyzes input to generate corresponding output, most often a classification and/or label of the input according to a particular framework.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A system for automated conversion of source database schema into data models for cloud-based data analytics platforms, the system comprising a server computing device having a memory for storing computer-executable instructions and a processor that executes the computer-executable instructions to:
identify database schema including one or more database tables in a source database for conversion;
extract metadata and schema information associated with the identified database schema from the source database;
convert the extracted metadata into a form compatible with a target cloud data analytics platform;
generate, using the converted metadata and the schema information, one or more code scripts comprising programmatic instructions to create a data model in the target cloud data analytics platform that is representative of the identified database schema;
execute the code scripts to create the data model in the target cloud data analytics platform; and
validate the created data model in the target cloud data analytics platform using the executed code scripts.

2. The system of claim 1, wherein the extracted metadata comprises column attributes for each of the database tables in the identified database schema.

3. The system of claim 2, wherein the column attributes comprise column name, data type, primary key, foreign key, and null value flag for each column in the database table.

4. The system of claim 3, wherein converting the extracted metadata into a form compatible with a target cloud data repository comprises:
updating the data type of one or more columns in the extracted metadata to match a target data type acceptable by the target data repository; and
appending a target prefix value to the column name of one or more columns in the extracted metadata.

5. The system of claim 1, wherein the schema information comprises one or more data elements identifying a relationship between one or more of the database tables.

6. The system of claim 1, wherein generating code scripts comprises:
selecting one or more code script templates for creating the data model in the target cloud data analytics platform; and
populating one or more dynamic fields in the code script templates with one or more of:
the converted metadata and the schema information.

7. The system of claim 1, wherein the one or more code scripts comprise programmatic instructions to load data from the source database into the target data analytics platform.

8. The system of claim 1, wherein validating the created data model comprises comparing one or more attributes of the executed code scripts to one or more attributes of the created data model for consistency.

9. A computerized method of automated conversion of source database schema into data models for cloud-based data analytics platforms, the method comprising:
identifying, by a server computing device, database schema including one or more database tables in a source database for conversion;
extracting, by the server computing device, metadata and schema information associated with the identified database schema from the source database;
converting, by the server computing device, the extracted metadata into a form compatible with a target cloud data analytics platform;
generating, by the server computing device using the converted metadata and the schema information, one or more code scripts comprising programmatic instructions to create a data model in the target cloud data analytics platform that is representative of the identified database schema;
executing, by the server computing device, the code scripts to create the data model in the target cloud data analytics platform; and
validating, by the server computing device, the created data model in the target cloud data analytics platform using the executed code scripts.

10. The method of claim 9, wherein the extracted metadata comprises column attributes for each of the database tables in the identified database schema.

11. The method of claim 10, wherein the column attributes comprise column name, data type, primary key, foreign key, and null value flag for each column in the database table.

12. The method of claim 11, wherein converting the extracted metadata into a form compatible with a target cloud data repository comprises:
updating the data type of one or more columns in the extracted metadata to match a target data type acceptable by the target data repository; and
appending a target prefix value to the column name of one or more columns in the extracted metadata.

13. The method of claim 9, wherein the schema information comprises one or more data elements identifying a relationship between one or more of the database tables.

14. The method of claim 9, wherein generating code scripts comprises:
selecting one or more code script templates for creating the data model in the target cloud data analytics platform; and
populating one or more dynamic fields in the code script templates with one or more of:
the converted metadata and the schema information.

15. The method of claim 9, wherein the one or more code scripts comprise programmatic instructions to load data from the source database into the target data analytics platform.

16. The method of claim 9, wherein validating the created data model comprises comparing one or more attributes of the executed code scripts to one or more attributes of the created data model for consistency.
